(19) United States
(12) Patent Application Publication
(10) Pub. No.: US 2009/0102745 A1
(43) Pub. Date: Apr. 23, 2009

(54) ELECTRONIC DEVICE

(75) Inventor: Chun-Kai Chan, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/253,226

(22) Filed: Oct. 16, 2008

(30) Foreign Application Priority Data
Oct. 23, 2007 (TW) 96139713

(51) Int. Cl. G09G 5/00

(52) U.S. Cl. 345/1.3

(57) ABSTRACT

An electronic device including a first display module, a second display module, a sensor, and a controller is provided. The second display module is independent from the first display module. The second display module and the first display module are located on the same surface of the electronic device. The sensor is used to detect an included angle between the electronic device and a basic axis and generates a display-switching signal in response to a result of detection. The controller is electrically connected to the sensor for receiving the display-switching signal and controllingly drives the first display module or the second display module for displaying according to the display-switching signal.

### CROSS-REFERENCE TO RELATED APPLICATION

This application claims the priority benefit of Taiwan application serial no. 96139713, filed on Oct. 23, 2007. The entirety of the above-mentioned patent application is hereby incorporated by reference herein and made a part of specification.

### BACKGROUND OF THE INVENTION

1. Field of the Invention

The present invention relates to an electronic device, in particular, to an electronic device capable of automatically selecting an appropriate display module to display a symbol in a correct orientation according to a different arrangement direction.

2. Description of Related Art

Currently, in the modern society that information exchanges rapidly, people gradually become dependent on electronic products. Accordingly, more and more humanized electronic products with powerful functions have been developed, and various electronic products such as notebook computers, handheld computers, personal digital assistants (PDAs), and multimedia peripheral electronic devices are used everywhere in daily life, which have become an indispensable part of the daily life.

Generally, as the electronic products are configured with complicated functions and the electronic products in multiple types have been proposed, more and more factors shall be considered when a user selects an electronic product, for example, whether the functions and the price are acceptable or not, or whether the product is designed for a high-end consumer or for a beginner, as well as the external appearance or material of the product. In order to select an electronic product easily, most of the users consider the brand as the most important criteria. A brand not only represents the quality of the product, but also shows a position of the brand owner in the user's mind, and thus, the brand building and marketing has become one of the most important issues that attract more and more attention of each enterprise. Therefore, the logo is tend to be designed at an eye-catching position on an electronic product, so as to show clearly.

However, the logo is generally shown at a fixed position on the case of a common electronic product. For example, the case is configured with a metal sheet with the logo carved thereon, by laser or by light emitting of light-emitting diodes (LEDs). When the electronic product stands upright or is laid down, the logo is turned into a vertical or horizontal status according to a position arrangement of the electronic product. As a result, the logo is sometimes reverse that make the user unable to easily identify the logo since he/she does not change his/her position, which obstructs a display of the brand. Furthermore, when the electronic product stands upright or is laid down, the directions of the key symbols on the electronic product are also changed, and accordingly, the user cannot easily identify the key symbols as well, which is rather inconvenient in usage.

### SUMMARY OF THE INVENTION

Accordingly, the present invention provides an electronic device, which is capable of enhancing an identifiability of a symbol on an electronic product when a status of the electronic device is changed.

As embodied and broadly described herein, the present invention provides an electronic device, which includes, but not limited to, a first display module, a second display module, a sensor, and a controller. The second display module is independent from the first display module. Both the second display module and the first display module are located on the same surface of the electronic device. The sensor is used to detect an included angle between the electronic device and a basic axis, and correspondingly generates a display-switching signal. The controller is electrically connected to the sensor for receiving the display-switching signal, and selectively drives the first display module or the second display module for displaying according to the display-switching signal.

In an embodiment of the present invention, the first display module and the second display module include a first power supply circuit and a second power supply circuit respectively. The first power supply circuit and the second power supply circuit are independent from each other. The controller controllingly supplies power to the first power supply circuit or the second power supply circuit according to the display-switching signal.

In an embodiment of the present invention, the first display module and the second display module include a first light source and a second light source respectively. The first light source is electrically connected to the first power supply circuit, and the second light source is electrically connected to the second power supply circuit. The first and second light sources may be, for example, light-emitting diodes (LEDs) or lamps.

In an embodiment of the present invention, the first display module and the second display module further include a first patterned light-transmissive portion and a second patterned light-transmissive portion respectively. The first patterned light-transmissive portion and the second patterned light-transmissive portion are respectively corresponding to the first light source and the second light source. Light-transmissive patterns of the first patterned light-transmissive portion and the second patterned light-transmissive portion may define a logo or at least one key symbol.

In an embodiment of the present invention, the first display module and the second display module further include a first light guide plate and a second light guide plate respectively. The first light guide plate is located between the first patterned light-transmissive portion and the first light source, and the second light guide plate is located between the second patterned light-transmissive portion and the second light source.

In an embodiment of the present invention, the electronic device further includes a light source and a light source switch. The controller controls the light source switch to allow lights emitted from the light source to transmit to the first display module or the second display module according to the display-switching signal. The light source may be an LED or a lamp.

In an embodiment of the present invention, the first display module and the second display module include a first patterned light-transmissive portion and a second patterned light-transmissive portion respectively. The controller controls the light source switch to allow lights emitted from the light source to transmit to the first patterned light-transmissive portion or the second patterned light-transmissive portion according to the display-switching signal.

In an embodiment of the present invention, the first display module and the second display module further include a first light guide plate and a second light guide plate respectively. The first light guide plate is located between the first patterned light-transmissive portion and the light source, and the second light guide plate is located between the second patterned light-transmissive portion and the light source. The light-transmissive patterns of the first patterned light-transmissive portion and the second patterned light-transmissive portion may define a logo or at least one key symbol.

In an embodiment of the present invention, the basic axis is vertical.

In an embodiment of the present invention, the sensor is a gravity sensor or a vertical gyro.

In an embodiment of the present invention, the first display module and the second display module may be an organic light-emitting diode (OLED) panels.

In an embodiment of the present invention, the electronic device is, for example, a notebook computer or a TV box.

In the present invention, the first display module or the second display module is selected to display a determined symbol by detecting a change of the included angle between the electronic device and the basic axis. Therefore, the displayed symbol is consistent with a direction along which a user views the symbol, so that the symbol is clearly identified by the user, and the symbol has a more pleasant look. Furthermore, if the displayed symbol is a key symbol, the user can clearly identify the key symbol even when the electronic device is arranged in a different direction, and thus the electronic device can be operated more conveniently.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic device according to an embodiment of the present invention.

FIG. 2A is a schematic view of the electronic device shown in FIG. 1, in which a first display module is selected for displaying.

FIG. 2B is a schematic view of the electronic device shown in FIG. 1, in which a second display module is selected for displaying.

FIG. 3 is a schematic view of a light source configuration manner for the electronic device shown in FIG. 2B.

FIG. 4 is a schematic view of another light source configuration manner for the electronic device shown in FIG. 2B.

FIG. 5A is a schematic view of an electronic device according to another embodiment of the present invention, in which the first display module is selected for displaying.

FIG. 5B is a schematic view of the electronic device according to another embodiment of the present invention, in which the second display module is selected for displaying.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

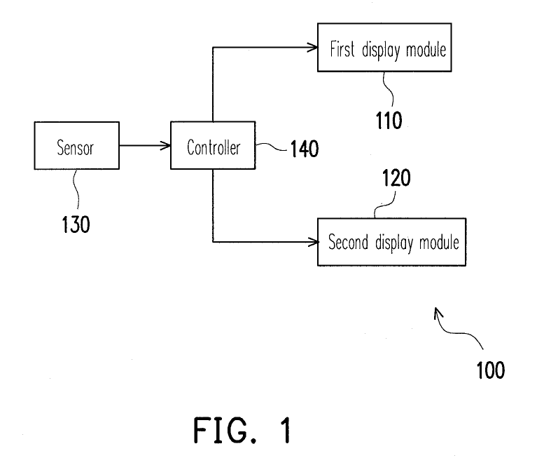

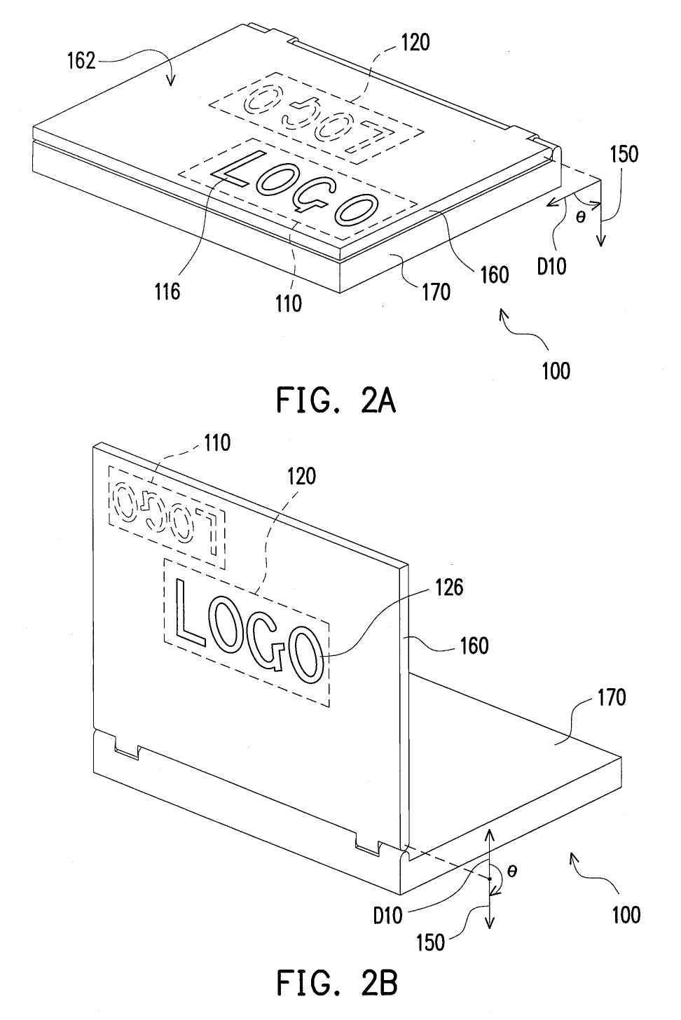

FIG. 1 is a block diagram of an electronic device according to an embodiment of the present invention, and FIG. 2A is a schematic view of the electronic device shown in FIG. 1, in which a first display module is selected for displaying. Referring to FIGS. 1 and 2A, an electronic device 100 includes a first display module 110, a second display module 120, a sensor 130, and a controller 140. The second display module 120 is independent from the first display module 110, that is, there are at least two display regions corresponding to the second display module 120 and the first display module 110 are separated from each other and do not overlap with each other. Furthermore, the second display module 120 and the first display module 110 are located on the same surface 162. The sensor 130 is used to detect an included angle θ between the electronic device 100 and a basic axis 150, and correspondingly generates a display-switching signal. The controller 140 is electrically connected to the sensor 130 for receiving the display-switching signal, and selectively drives the first display module 110 or the second display module 120 for displaying according to the display-switching signal.

In this embodiment, the electronic device 100 is, for example, a notebook computer. In this case, the electronic device 100 further includes a screen 160 and a base 170. The screen 160 is pivoted to the base 170, so that the screen 160 may be pivotally rotated with respect to the base 170, so as to be opened (as shown in 2B). The first display module 110 and the second display module 120 are used to display a logo of the electronic device 100. However, in an alternative embodiment, the first display module 110 and the second display module 120 may also be used to display a key symbol or any desired image. Furthermore, the direction of the basic axis 150 may be vertical. The sensor 130 may be a gravity sensor, a vertical gyro, or any other sensor that can sense a direction change. The sensor 130 is, for example, disposed in the screen 160, so as to detect an included angle θ between the screen 160 and the basic axis 150.

In particular, the relative position between the first display module 110 and the second display module 120 remains fixed. The sensor 130 is used to detect the included angle θ between a reference direction D10 and the basic axis 150. The reference direction D10 varies depending upon a portion of the electronic device 100 where the first display module 110 and the second display module 120 are mounted, that is, the reference direction D10 is relatively fixed with respect to the portion of the electronic device 100 where the first display module 110 and the second display module 120 are mounted.

Referring to FIGS. 1 and 2B, when the screen 160 is opened, the sensor 130 senses the included angle θ between the reference direction D10 associated with the screen 160 and the basic axis 150 through a variation of an acceleration generated when the screen 160 is turned, so as to generate a display-switching signal. Referring to FIGS. 2A and 2B, after the controller 140 (shown in FIG. 1) receives the display-switching signal, the controller 140 controls the switching between the first display module 110 and the second display module 120, so that the logo displayed by the first display module 110 in FIG. 2A is switched to be displayed by the second display module 120 in FIG. 2B.

It should be noted that, the controller 140 drives the first display module 110 or the second display module 120 for displaying according to the included angle θ sensed by the sensor 130. Therefore, when the screen 160 is closed or opened, the arranging direction of the logo is not reversed vertically or horizontally. Thus, the logo has a more pleasant look, and users can identify the logo clearly.

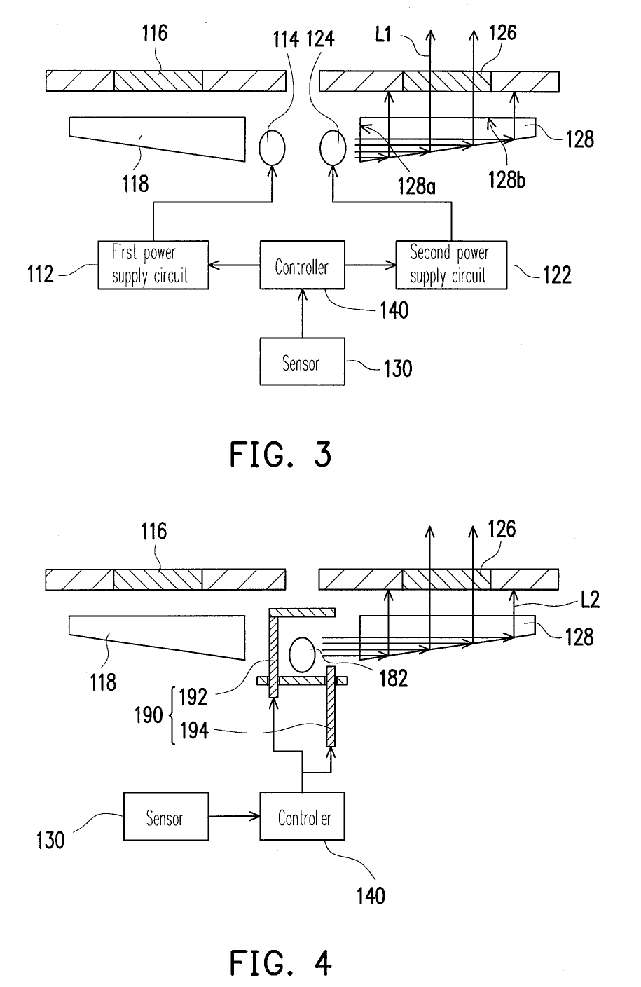

FIG. 3 is a schematic view of a light source configuration manner for the electronic device shown in FIG. 2B. Referring to FIG. 3, in this embodiment, each of the first display module 110 and the second display module 120 uses, for example, a light source of a light-emitting diode (LED) or a lamp for displaying. In an alternative embodiment (not shown), the first display module 110 and the second display module 120 may be organic light emitting diode (OLED) panels. In this embodiment, the first display module 110 and the second display module 120 include a first power supply circuit 112 and a second power supply circuit 122 respectively. The first power supply circuit 112 and the second power supply circuit 122 are independent from each other. Furthermore, the first display module 110 and the second display module 120 further include a first light source 114 and a second light source 124 respectively. The first light source 114 is electrically connected to the first power supply circuit 112, and the second light source 124 is electrically connected to the second power supply circuit 122.

Moreover, the first display module 110 and the second display module 120 further include a first patterned light-transmissive portion 116 and a second patterned light-transmissive portion 126 respectively. The first patterned light-transmissive portion 116 and the second patterned light-transmissive portion 126 are respectively corresponding to the first light source 114 and the second light source 124. In addition, the first display module 110 and the second display module 120 further include a first light guide plate 118 and a second light guide plate 128 respectively. The first light guide plate 118 is located between the first patterned light-transmissive portion 116 and the first light source 114, and the second light guide plate 128 is located between the second patterned light-transmissive portion 126 and the second light source 124.

In particular, taking the second display module 120 for an example, the second light source 124 is, for example, disposed on one side of a light incident surface 128a of the second light guide plate 128, and the second patterned light-transmissive portion 126 is disposed corresponding to a light emergent surface 128b of the second light guide plate 128. In this embodiment, the light is, for example, irradiated on the second display module 120 from a side edge. However, in an alternative embodiment, the second display module 120 is used for displaying under a direct-type back light.

The controller 140 controllingly supplies power to the first power supply circuit 112 or the second power supply circuit 122 according to the display-switching signal. When the controller 140 controls to supply power to the second power supply circuit 122, the light L1 emitted from the second light source 124 passes through the second patterned light-transmissive portion 126 via the second light guide plate 128, so as to display the logo (shown in FIG. 2B).

FIG. 4 is a schematic view of another light source configuration manner for the electronic device shown in FIG. 2B. The light source configuration manner is similar to that shown in FIG. 3, so the same elements in FIGS. 3 and 4 are marked by the same reference numerals and the descriptions thereof are omitted here. Referring to FIG. 4, the electronic device 100 further includes a light source 182 and a light source switch 190. The light source 182 includes, for example, an LED or a lamp. The controller 140 controls the light source switch 190 to allow the light L2 emitted from the light source 182 to transmit to the first patterned light-transmissive portion 116 or the second patterned light-transmissive portion 126 according to the display-switching signal.

In particular, under this light source configuration manner, the light source switch 190 for example includes a first shielding element 192 and a second shielding element 194. The first shielding element 192 and the second shielding element 194 are respectively used to shield the light L2 from entering the first light guide plate 118 and the second light guide plate 128. The first shielding element 192 and the second shielding element 194 are movable, which are, for example, driven by a motor (not shown) and a plurality of gears (not shown) engaged with one another. The controller 140 may be electrically connected to the first shielding element 192 and the second shielding element 194, so as to control the movement of the first shielding element 192 and the second shielding element 194. When the screen 160 is in an open state with respect to the base (as shown in FIG. 2B), the controller 140 controls the movement of the first shielding element 192 to shield the light L2 from entering the first light guide plate 118, and controls the movement of the second shielding element 194 to enable the light L2 to transmit to the second patterned light-transmissive portion 126 through the second light guide plate 128.

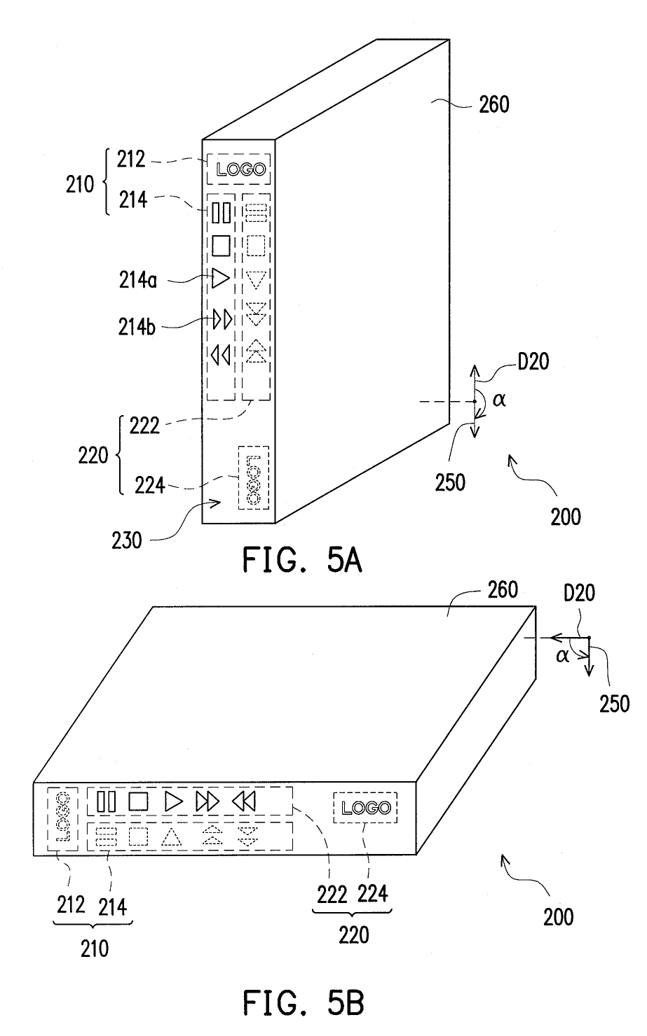

FIG. 5A is a schematic view of an electronic device according to another embodiment of the present invention, in which the first display module is selected for displaying. Referring to FIG. 5A, the electronic device 200 is, for example, a TV box, for processing TV signals displayed by a display device (not shown). The electronic device 200 includes a first display module 210 and a second display module 220. Furthermore, the second display module 220 and the first display module 210 are located on the sane surface 230. The first display module 210 may include a first logo display region 212 and a first key symbol display region 214, and the second display module 220 may include a second logo display region 222 and a second key symbol display region 224. The first key symbol display region 214 and the second key symbol display region 224 are used to display positions of keys and to denote functions thereof, for example, a play key 214a, a fast forward key 214b, and the like.

This embodiment is similar to the above embodiment, but the difference lies in that in the above embodiment, the first display module 110 and the second display module 120 are used to display the logo, and they are switched as the screen 160 is opened or closed; whereas in this embodiment, the first display module 210 and the second display module 220 are used to display the logo and the key symbols, and they are switched according to an arranging angle of a case 260.

Referring to FIGS. 5A and 5B, when the electronic device 200 is laid horizontally from a status of standing up vertically, an included angle a between a reference direction D20 and a basic axis 250 of the electronic device 200 is changed, so that the controller (not shown) receives the display-switching signal from the sensor (not shown). Accordingly, the controller controls the first display module 210 not to display, but controls the second display module 220 for displaying. In this embodiment, the arranging direction of the logo displayed by the first logo display region 212 and the second logo display region 222 will not be reversed horizontally or vertically, and the key symbols on the first key symbol display region 214 and the second key symbol display region 224 will not be reversed horizontally or vertically as well, so as to provide a better viewing angle to users.

To sum up, the electronic device of the present invention selects the first display module or the second display module to display various symbols (such as a logo or key symbols) by detecting an included angle between the electronic device and the basic axis, so that the arrangement of the displayed symbols are not reversed horizontally or vertically with the change of the arranging direction of the electronic device. Therefore, the user can clearly identify the displayed symbol, and the symbol has a more pleasant look. Meanwhile, when the displayed symbols are key symbols, the user can still clearly identify each key symbol even when the arranging direction of the electronic device is changed, and thus the electronic device can be operated more conveniently.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device, comprising:
a first display module;
a second display module, being independent from the first display module, wherein the second display module and the first display module are located on the same surface of the electronic device;
a sensor, for detecting an included angle between the electronic device and a basic axis, and correspondingly generating a display-switching signal; and
a controller, electrically connected to the sensor to receive the display-switching signal and selectively driving the first display module or the second display module for displaying according to the display-switching signal.

2. The electronic device according to claim 1, wherein the first display module and the second display module comprise a first power supply circuit and a second power supply circuit respectively, the first power supply circuit and the second power supply circuit being independent from each other, and the controller controllingly supplying power to the first power supply circuit or the second power supply circuit according to the display-switching signal.

3. The electronic device according to claim 2, wherein the first display module and the second display module comprise a first light source and a second light source respectively, the first light source being electrically connected to the first power supply circuit, and the second light source being electrically connected to the second power supply circuit.

4. The electronic device according to claim 3, wherein the first light source and the second light source being light-emitting diodes (LED) or lamps.

5. The electronic device according to claim 3, wherein the first display module and the second display module further comprise a first patterned light-transmissive portion and a second patterned light-transmissive portion respectively, and the first patterned light-transmissive portion and the second patterned light-transmissive portion being respectively corresponding to the first light source and the second light source.

6. The electronic device according to claim 5, wherein the first display module and the second display module further comprise a first light guide plate and a second light guide plate respectively, the first light guide plate being located between the first patterned light-transmissive portion and the first light source, and the second light guide plate being located between the second patterned light-transmissive portion and the second light source.

7. The electronic device according to claim 5, wherein light-transmissive patterns of the first patterned light-transmissive portion and the second patterned light-transmissive portion are logos or at least one key symbol.

8. The electronic device according to claim 1, further comprising a light source and a light source switch, wherein the controller controls the light source switch to allow a light emitted from the light source to transmit to the first display module or the second display module according to the display-switching signal.

9. The electronic device according to claim 8, wherein the light source comprises an LED or a lamp.

10. The electronic device according to claim 8, wherein the first display module and the second display module comprise a first patterned light-transmissive portion and a second patterned light-transmissive portion respectively, and the controller controls the light source switch to allow the light emitted from the light source to transmit to the first patterned light-transmissive portion or the second patterned light-transmissive portion according to the display-switching signal.

11. The electronic device according to claim 10, wherein the first display module and the second display module comprise a first light guide plate and a second light guide plate respectively, the first light guide plate being located between the first patterned light-transmissive portion and the light source, and the second light guide plate being located between the second patterned light-transmissive portion and the light source.

12. The electronic device according to claim 10, wherein light-transmissive patterns of the first patterned light-transmissive portion and the second patterned light-transmissive portion are logos or at least one key symbol.

13. The electronic device according to claim 1, wherein the basic axis is vertical.

14. The electronic device according to claim 1, wherein the sensor is a gravity sensor or a vertical gyro.

15. The electronic device according to -claim 1, wherein the first display module and the second display module are organic light emitting diode (OLED) panels.

16. The electronic device according to claim 1, wherein the electronic device is a notebook computer or a TV box.
